(19) United States
(12) Patent Application Publication
(10) Pub. No.: US 2006/0015467 A1
(43) Pub. Date: Jan. 19, 2006

(54) Internet services quoting system and method

(76) Inventors: David Morken, Chapel Hill, NC (US); Henry Kaestner, Durham, NC (US)

Correspondence Address: YOUNG & THOMPSON, 745 SOUTH 23RD STREET, 2ND FLOOR, ARLINGTON, VA, 22202, US

(21) Appl. No.: 11/144,793

(22) Filed: Jun. 6, 2005

Related U.S. Application Data
(60) Provisional application No. 60/576,614, filed on Jun. 4, 2004.

(51) Int. Cl. G06F 17/00

(52) U.S. Cl. 705/400

(57) ABSTRACT

A method and system assists a consumer in selecting and purchasing internet services through a computer based communication system. The method and system provides an internet user real-time pricing and service quotes for internet services through the use of XML documents sent via HTTP Post.

### FIELD OF INVENTION

The invention concerns a method and system for assisting a consumer, i.e., an internet user, in selecting and purchasing internet services through a real-time computer based communication system. The method and system of the invention provides an internet user real-time pricing and other service quotes for internet services.

### BACKGROUND OF THE INVENTION

On-line shopping is quickly becoming the preferred means for obtaining consumer products and services. Consumers are increasingly using the Internet to browse, comparison shop and order products on-line.

Online shopping systems have made product information such as pricing and availability readily available to consumers. Online shopping systems also facilitate the location and purchasing of desired products at a lower cost and with added convenience. For example, United States Patent Application Publication U.S. 2002/0174019 discloses a method wherein a consumer can request price quotes for tires from area retail dealers, and then later receive a quote directly from the dealer. Such systems, however, are not real time responsive.

For a limited number of goods and services, consumers may obtain real-time price quotes and offers. U.S. Pat. No. 6,711,495 discloses a method and apparatus for gathering vehicle information on a real time basis. Such systems are tightly integrated from the information request through the returning response steps.

However, this approach is not possible for all information requests, especially when dealing with multiple, disparate vendor information sources or multiple, disparate requesting users. In an environment with different vendor information sources (carrier quoting systems and carrier databases) and different requesting users running on different client platforms, the request, analysis, and response procedure is not tightly integrated.

Consider the selection and purchase of internet services by an ultimate end-user consumer who must either deal directly with plural internet carriers/vendors (which is time consuming and may be frustrating) or deals with an internet services co-ordination agent (reseller) who has relationships with the plural internet carriers and can verify which carriers provide the desired internet services in the end-user consumer's area.

Although use of an internet services co-ordination agent saves the consumer time and effort, e.g., bandwidth pricing has remained a relatively time-consuming process. The nature and complexity of providing offers and price quotes for internet services prevented internet services co-ordination agents/companies from providing this information in a prompt and timely manner.

The process was time consuming because the consumer provided service requests to an agent/reseller who, in turn, generally needed to access each carrier's (vendor's) extranet or other available data system in order to individually compile a quote for each carrier. The flow of information was generally from human-to-computer or human to human due to the disparate nature of the requesting process and the plural data systems that needed to interact. That is, the time between making a pricing request and receiving an offer from an internet service vendor would be delayed, for example, by over 45 minutes.

In an environment of increased consumer expectations, such a delay was increasingly unacceptable to consumers.

Bandwidth.com, a wholesaler and sales agent of internet services, developed a system in an effort to address this prior art shortcoming (see, K. Kennedy, BANDWIDTH.COM TEAMS WITH VAR IN ONLINE PORTAL DEAL: Solution gives Insight Direct access to realtime quotes, order tracking, published by crn.com, Mar. 13, 2002).

Further, Bandwidth.com constructed a website that provided online price quotes and offers for T1 and Fractional T1 internet service with an improved response time.

### SUMMARY OF THE INVENTION

To achieve more true real-time responses and thereby satisfy increasing consumer demands, the present invention provides an improved method and system that gives the consumer the ability to obtain real-time pricing and service quotes by flexibly interfacing with disparate user applications, for originating and requesting internet service quotes, and interfacing with vendor information/pricing applications providing information for making responsive offers to the users' requests for service quotes.

The present invention further enables consumers and users to obtain real-time price quotes, via an internet services co-ordination agent (reseller) from multiple bandwidth carriers (vendors) verified to provide service in the consumer's area.

In particular, the present invention provides a real-time solution utilizing a user's computer or a user's client system to create a service request in the form of an Extensible Markup Language (XML) document that is sent as a hypertext transfer protocol Post (HTTP POST) request into a pricing/quoting system of the reseller.

The present invention allows consumers and other users to obtain pricing and order internet related services in real time without the need for tight integration, e.g., limited to a single central website, e.g., bandwidth.com's website. Thus, the present invention provides a flexible system for interfacing with a reseller's pricing/quoting system.

The present invention allows more convenient co-operation between an ultimate internet services end-user, an internet services co-ordination agent (reseller), and plural ultimate internet carriers/vendors.

The user of the present invention can be both a consumer on its own behalf or a consumer that wants to market to others. The present invention enables the consumer, on its own behalf, to price and buy internet related services. Alternatively, the present invention enables the consumer that wants to market to others to price-and sell internet related services within their own computer applications and servers as a front end.

In both cases, the present invention can do so by originating and sending into the pricing/quoting system the internet service request via the Extensible Markup Language (XML) document (via HTTP Post request). The present invention thereby eliminates the need for extensive programming to meet the strict integration requirements of the prior art.

In view of these features, the present invention relates to a method and system that assists an internet user in selecting and purchasing internet services through a computer based communication system. The method and system provides a consumer real-time pricing and service quotes for internet services.

The present invention further provides a real-time solution utilizing a user's computer or client system that interacts with a pricing request application to create an XML request that is delivered as an HTTP Post request to the internet pricing website or pricing application.

Additional advantages and features of the present invention will become apparent from the subsequent description and claims taken in conjunction with the accompanying drawings.

### BRIEF DESCRIPTION OF THE DRAWING FIGURES

FIG. 1 exemplifies the real-time method and system of the present invention.

FIG. 2 shows an example of the XML API method and system according to the present invention.

FIG. 3 illustrates an example of the synchronous method of the XML API method and system of the present invention.

FIG. 4 exemplifies the asynchronous method of the XML API method and system of the present invention.

### DESCRIPTION OF THE PREFERRED EMBODIMENTS

The present invention provides real-time pricing for internet services that include, but are not limited to, Asymmetric Digital Subscriber Line (ADSL), Cable, Satellite, Symmetric Digital Subscriber Line (SDSL), Fractional T1, Full T1, N×T1, T3, fiber optic services, OC3, OC12, OC48, and Voice Over Internet Protocol (VOIP).

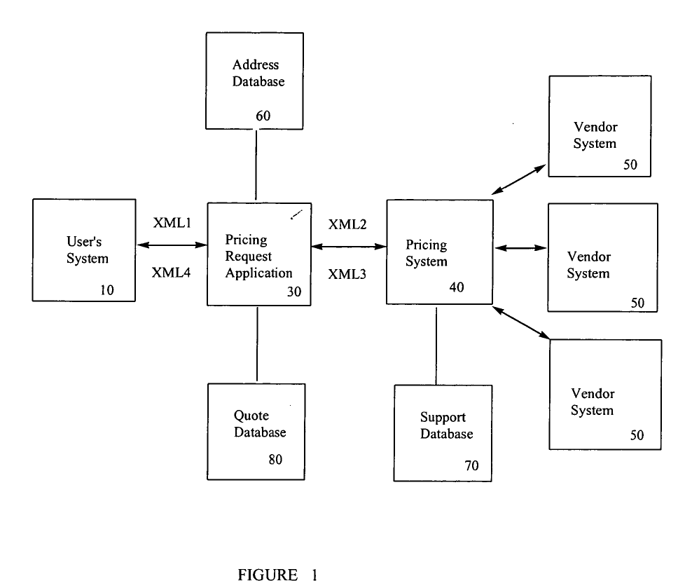

Referring to FIG. 1, there is illustrated an overview of the real-time method and system of the present invention.

Real-time is a flexible term with respect to a given application and time response requirement. The present invention accommodates this flexibility as described further below. The actual time involved in providing a real-time price quote and offer may vary depending on the nature of the computer systems involved and timing decisions made by the requesting user.

In the present invention, a real-time price quote and offer for internet services can be delivered to an internet user anywhere from near zero seconds to about twenty minutes. In preferred embodiments, a real-time price quote and offer for internet services can be delivered to an internet user within about 15 minutes, within about 10 minutes, or within about 5 minutes. Most preferably, the invention responds with a quote offer within about 120 seconds; still more preferably within about 45 seconds and within about 30 seconds. Embodiments responding within about 15 seconds, within about 10 seconds, and within about 5 seconds may also be configured.

The term “Customer” is used herein interchangeably with the term “Consumer” or “User”. The terms Customer and User encompass any individual, group, business, system, entity or entities which are interested in obtaining at least one price quote and offer for an internet service.

The customer initiates an internet services request via a User Service Request Application 10. The user can initiate a request for internet services from a computer system hosting the User Service Request Application or via a network (website) link to a remote computer hosting the User Service Request Application 10. As used herein, a computer system is a programmable electronic machine for processing information. The user, in typical embodiments, begins by inputting the type of internet service required, street address, city, state, zip code, and telephone number into an input screen provided by the User Service Request Application. This request information is sent by the user for processing, i.e., as a properly formatted XML document via an HTTP Post to a Pricing Request Application 30 (See XML1 of FIG. 1).

The Pricing Request Application 30 may reside on a server. A server is defined as at least one computer or device on a network that manages network resources. The server operates under direction of at least one software module, e.g., the Pricing Request Application 30 directing the server to review an address database 60 to verify the accuracy of the request's telephone number, verify the city, state and zip code.

Another software module of the Pricing Request Application can also direct the server to provide a number of other preliminary tasks. For example, a software module can also direct the server to calculate the straight-line distance between the located central office and a user's location.

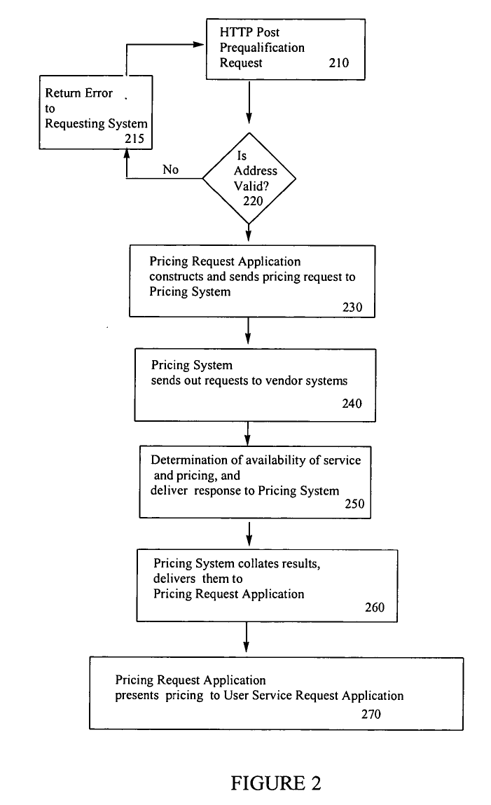

The Pricing Request Application interfaces (see XML2 of FIG. 1) with a Pricing System 40 which may reside on the same server as the Pricing Request Application 30. The Pricing Request Application may direct the server to determine which internet service vendors 50 in the user's location provide the type of internet service requested by the user. Then the Pricing System formulates and transmits an internet service pricing request (a solicitation) to each of the identified vendors 50. Alternatively, the solicitations can be sent to all vendors, and then based on vendor responses; the Pricing System determines availability of service (See step 240-250 of FIG. 2). The information required by each vendor will vary from vendor to vendor and thus the solicitations must be in a format suitable for each vendor.

As a result, each vendor may receive an internet service pricing request that is unique. That is, each internet service pricing request is specially formatted in to a solicitation for internet services to a particular vendor's format needs. As the requirements of each vendor system may vary, each vendor system typically requires a different format.

Vendor system access methods include but are not limited to website screen scraping, XML via HTTP POST, and web services (e.g., Simple Object Access Protocol [SOAP] protocol). For some internet services, the information can be stored on a local database and accessed locally; that is, on the same server as hosting the Pricing System 40.

Screen scraping is a particularly useful way to obtain data from the vendors, particularly since the response from some vendor's extranets will be in the form of a web page which includes various extraneous data and screen scraping allows the extraction of only the needed information. A software module within the Pricing System will also include any necessary passwords or other identifiers required by each vendor such as vendor logos or other information.

After the internet service pricing request solicitations are generated and sent to each of the identified vendors, the Pricing System simultaneously is set to receive proposals from each of the vendors. Once again, the format and information contained in each proposal varies from each of the vendors. The Pricing system is configured to handle each proposal in an appropriate manner. The Pricing System, as the proposals are received, will compile all of the service and price offer summary responses in an easily-readable format for the user. Data may be stored and accessed from a Pricing Support Database 70.

With reference to FIG. 1, the Pricing System 40, responsive to the solicitations, receives internet service proposals from the internet vendors 50. The received proposals comprise data regarding characteristics of offered internet services and pricing for the offered internet services such as locations served and costs. As mentioned above, the Pricing System 40 collates the data from the received proposals into a service and price offer summary in which disparate characteristics of offered internet services are grouped into groupings of comparable characteristics. For example, T1 offers, ADSL offers, and cable offers with comparable characteristics are grouped together in ascending price order.

The Pricing System 40 thereafter returns (XML3) the service and price offer summary to the Pricing Request Application 30 for further forwarding (XML4) to the User Service Request Application 10. XML4 results from the Pricing Request Application 30, after receiving the service and price offer summary, reformatting the service and price offer summary into a returned XML document readable by the User Service Request Application 10 for presenting the service and price offer summary to the user as a real-time response to the user's sent pricing request.

Again referring to FIG. 1, a user accesses a User Service Request Application 10 which may be a dedicated coded application running on the user's PC or a website accessed via a web browser, the website running remote from the user's PC. As discussed, the User Service Request Application 10 allows a customer to obtain a real-time service and price offer summary responsive to the user-originated internet service pricing request. The customer may be the user or an agent for a consumer or customer, for example a business that runs the website embodiment of the User Service Request Application.

The user may initiate and construct a pricing request for internet services by completing a request form generated by the User Service Request Application 10. The internet services pricing request is output from the User Service Request Application (XML1) in the form of a properly formatted XML document.

The internet services pricing request in the form of the XML document is then forwarded to the Pricing Request Application 30 as an HTTP Post request (XML1). The Pricing Request Application 30, after receiving the pricing request, reformats the received internet pricing request into an output XML document (XML2). The output XML document is forwarded to the Pricing System 40 again as an HTTP Post request.

The Pricing System 40 formats the data from the received output XML document into multiple solicitations for internet services. The solicitations are forwarded to the appropriate internet service vendors, or to all vendors, as desired. For example, if the user requests a price and offer for T1 service, the solicitations will be forwarded to vendors that offer that service or to all vendors to see who offers T1 at the user's location. As the system requirements of each vendor may vary, each solicitation is formatted in a manner so that it is acceptable to at least one of a plurality of vendors 50.

The Pricing System 40 receives, responsive to the solicitations, internet service proposals from the multiple internet vendors 50. The received proposals contain data that describes the nature and type of internet service offered by each vendor 50 in response to the solicitation.

The Pricing System 40 obtains and collates the data from the received proposals into the service and price offer summary in which the characteristics of the offered internet services from the vendors 50 are grouped into groupings of comparable characteristics of offered internet services.

The Pricing System 40 delivers the service and price offer summary in the form of an XML document (XML3) to the Pricing Request Application 30 for forwarding as a response (XML4) to the User Service Request Application 10. The Pricing Request Application 30, after receiving the service and price offer summary as the XML3 document, reformats the service and price offer summary into the XML document XML4, which is delivered to the User Service Request Application 10. XML4 serves as a real-time response to the user's sent internet service pricing request that may be presented to the user as a screen of the User Service Request Application 10.

Keeping FIG. 1 in mind, FIG. 2 shows a further embodiment of the present invention. The request for internet services is sent via an HTTP POST prequalification request in step 210 to the Pricing Request Application 30. The request, as extracted from XML1, is then analyzed to determine if the address is valid in step 220. If the address is not valid, a return error is delivered to the requesting system in step 215. If the address is valid, the request is further processed by the Pricing Request Application 30 to construct and deliver the pricing request to the Pricing System 40 in step 240.

Thus, the XML1 HTTP POST request is sent to the Pricing Request Application 30 for the purposes of i) validation and ii) formatting. The HTTP Post is processed from the format provided by the User Service Request Application 10 (a general client application transmitting a general XML document) to another XML document XML2 in a format acceptable to the Pricing System 40, i.e., including application data required by the Pricing System 40.

Similarly, as each vendor 50 may require that the solicitation request be formatted in a different manner, the Pricing System 40 in step 240 formats the request so that the request can be forwarded to a plurality of internet service vendors 50 in step 250. The availability of service and price is determined by each vendor and a response from each vendor, in the form of an internet service proposal, is returned to the Pricing System 40 in step 260.

Each internet service proposal contains data which characterizes the price and services offered by the vendor, see step 250. The Pricing System 40 extracts and collates all of the internet service proposals received from the vendors so that disparate characteristics of the offered internet services are categorized into groupings of comparable characteristics, e.g., service offerings.

The Pricing System 40 delivers the collated data and internet service proposals in the form of a service and price offer summary to the Pricing Request Application 30 in step 260 by way of XML3. The Pricing Request Application 30 in step 270 delivers by XML4 the service and price offer summary to the user as a real-time response to the user's request for internet services. That is, XML4 is sent to the User Service Request Application 10 for presentation to the user.

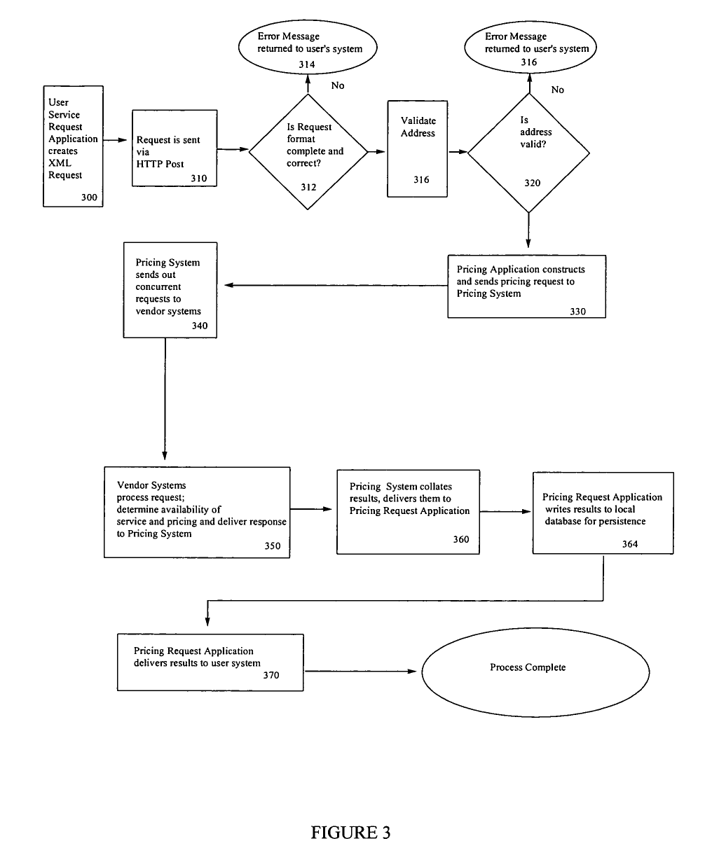

FIG. 3 shows an XML API process flow of the present invention utilizing a synchronous method. In the synchronous method, the client system creates a request for pricing in step 300 (XML1); sending XML1 to the Pricing Request Application in step 310. After sending the request XML1, the User Service Request Application 10 stays connected to the Pricing Request Application (an XML API system) until the results are returned. This is not an indefinite wait, but rather may be user selectable. The user prescribes the amount of time that they are willing to wait. That is, a wait time is set within the User Service Request Application 10. Any results not returned in that amount of time are not returned to the User Service Request Application 10.

Upon receiving the XML1 request from a user's system in step 312 via HTTP Post, the request is reviewed to assure that the request is complete and correct. If the request is incorrect or incomplete, an error message is returned to the user's system by step 314 (i.e., to the User Service Request Application 10). If the request is complete and correct, the address is reviewed to determine whether it is valid in step 316. If address is not valid (step 320), an error message is returned to the user's system (step 318).

If the address is valid (step 320), the request is further processed in the Pricing Request Application to construct and send the XML2 request for internet services to the Pricing System 40 (step 330). The pricing system (step 330) formats the data so that the availability of service and price for an internet service can be determined from among the multiple vendors 50 (during step 350) after sending in step 340.

An internet service proposal is generated from each vendor system in step 350. Each internet service proposal contains disparate data which characterizes the price and services offered by the vendor. The Pricing System in step 360 receives the proposals, extracts and collates data from all of the internet service proposals received from the vendors (step 360) so that disparate characteristics of the offered internet services are categorized into groupings of comparable characteristics.

The Pricing System 40 delivers the collated data and internet service proposals in the form of a service and cost offer summary as XML3 to the Pricing Request Application (in step 360). The Pricing Request Application 30 may write the received summary results to local databases for persistence (see step 364). The Pricing Request Application 30 delivers the service and price offer summary as XML4 to the User Service Request Application as a real-time response (step 370) to complete the process (step 380) by displaying that offer summary to the user.

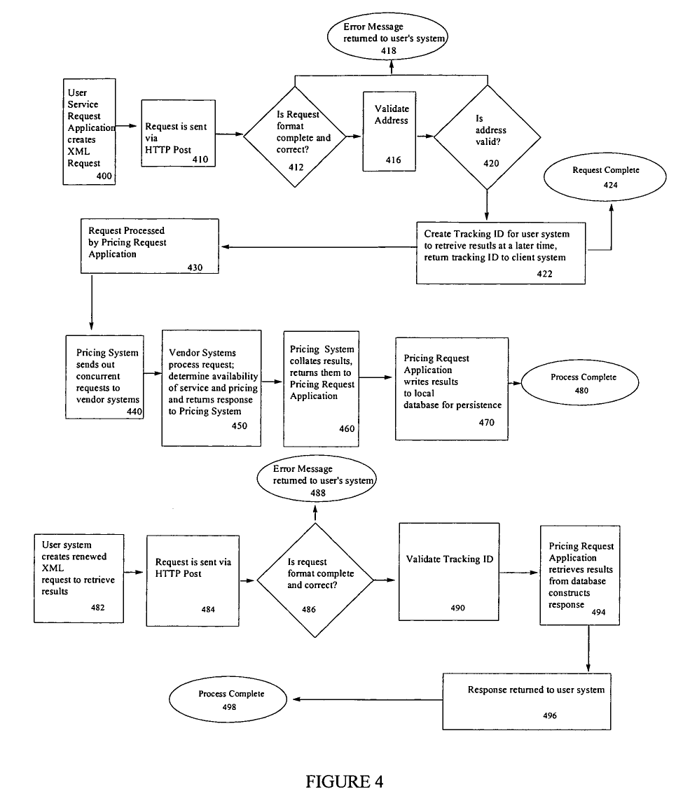

FIG. 4 shows an XML API process flow of the present invention by way of an asynchronous method. As to the asynchronous method, the user generates XML1 from the user's system (step 400). The XML1 request is sent via an HTTP POST (step 410) to the Pricing Request Application 30. The request is first reviewed to make sure that it is complete and correct (step 416) and to assure that the address is valid (step 420). Of course if either of these incomplete, incorrect, or invalid, an error message is returned to the client (step 418); to the User Service Request Application 10.

However, as opposed to a synchronous XML API method exemplified in FIG. 3, a tracking ID is created so that the User Service Request Application can retrieve results at a later time and the user request is complete for the time being (step 422).

The User Service Request Application in step 400 can return to the Pricing Request Application 30 at a later time to retrieve the requested information. Typically, the return for the requested information is after about 30 seconds. Two calls to the Pricing Request Application are required to accomplish the same result as one synchronous request, due to the needed return call and reconnection. However, by using two calls, system resources are conserved both at the user's PC and XML API systems of the Pricing Request Application 30 while the processing of the Pricing System and vendor systems are occurring.

After the tracking ID is created, the request is processed via the Pricing Request Application 30 to construct and send a request for internet services to the Pricing System (step 430). The Pricing System (step 440) formats the data so that the availability of service and price for an internet service can be determined from among multiple vendors (450) via solicitations.

An internet service proposal is generated by each vendor system (step 450). Each internet service proposals together contain disparate data which characterizes the price and services offered by the vendor (step 450). The Pricing System (step 460) collates all of the internet service proposals received from the vendors (at step 450) so that disparate characteristics of the offered internet services are categorized. The collated data and internet service proposals are in the form of a service and cost offer summary, and are sent to the Pricing Request Application 30 as XML3 in the form of an XML document (step 460). The Pricing Request Application writes the results to local database 80 for persistence (step 470).

As to the retrieval of information at a later time, the User Service Request Application 10 creates an additional XML request to retrieve the results (step 482); that is a second, renewed XML1. This renewed request is sent via an HTTP POST from the user system 10 again to the Pricing Request System 30. Again, the request is reviewed to make sure that it is complete and correct (step 486). However, the tracking ID that was previously generated (step 422) is checked to make sure that it is valid (step 492). If either the request is not proper (i.e. complete and correct), or if the ID is invalid, an error message is returned (step 488).

If the ID is valid and the request is proper, the offer results are retrieved from database 80 that previously stored this information and then constructs a response in the form of a service and price offer summary XML4 (step 494).

What is claimed is:

1. A real-time method for pricing internet services, comprising the steps of:
a user accessing a User Service Request Application (10) allowing a customer to obtain a real-time service and price offer summary responsive to a user-originated internet service pricing request;
the user initiating and constructing, from a user's computer running the User Service Request Application, the pricing request for internet services by completing a request form generated by the User Service Request Application, the internet service pricing request being output as a properly formatted XML document;
sending the pricing request from the user's computer to a Pricing Request Application (30) as an HTTP Post request for subsequent reformatting and forwarding by the Pricing Request Application;
the Pricing Request Application, after receiving the pricing request, reformatting the received internet pricing request into an output XML document in a form usable by a Pricing System (40);
the Pricing Request Application (30) sending the output XML document by HTTP Post request to the Pricing System (40);
the Pricing System (40) formatting the output XML document into plural internet vendor service solicitations, each of the solicitations being in a format acceptable to one of the plural vendors (50) and sending the solicitations the appropriate vendors (50);
the Pricing System (40)receiving, responsive to the solicitations, internet service proposals from the internet vendors (50), the received proposals comprising data regarding characteristics of offered internet services and pricing for the offered internet services;
the Pricing System (40) collating the data from the received proposals into the service and price offer summary in which disparate characteristics of the offered internet services from the vendors (50) are grouped into groupings of comparable characteristics of offered internet services with corresponding pricing;
the Pricing System (40)returning the service and price offer summary to the Pricing Request Application (30) for further forwarding to the User Service Request Application (10); and
the Pricing Request Application (30), after receiving the service and price offer summary, reformatting the service and price offer summary into a returned XML document readable by the User Service Request Application (10) for presenting the service and price offer summary to the user as a real-time response to the user's sent pricing request.

2. The method of claim 1, wherein the User Service Request Application communicates over a computer network via HTTP Post.

3. The method of claim 1, wherein the XML documents of the HTTP Posts are exchanged by one of a synchronous method and an asynchronous method.

4. The method of claim 3, wherein the HTTP Posts are exchanged by the synchronous method, the synchronous method comprising:
a maintained connection between the User Service Request Application (10) on the user's computer and the Pricing Request Application from a time of sending the internet services pricing request until a time of receiving the presented service and price offer summary by the User Service Request Application (10) on the user's computer; and
setting a user-set wait time for presenting the service and price offer summary; and
wherein only the internet service proposals received during the wait time are included in the offer summary presented to the User Service Request Application (10) on the user's computer.

5. The method of claim 3, wherein the HTTP Posts are exchanged by the asynchronous method, the asynchronous method comprising:
the User Service Request Application (10) on the user's computer receiving tracking information from the Pricing Request Application after sending the internet services pricing request, the tracking information being for re-establishing an asynchronous connection between the User Service Request Application (10) on the user's computer and the Pricing Request Application; and
the User Service Request Application (10) on the user's computer sending the tracking information to the Pricing Request Application to re-establish the asynchronous connection enabling the Pricing Request Application to present the offer summary.

6. The method of claim 1, wherein requested internet services include each of ADSL, cable, satellite, SDSL, T1, T3, fractional T1, N×T1, burstable T1, fiber optic service, OC3, OC12, OC48, and VOIP.

7. The method of claim 1, wherein the internet vendor service solicitation is in the form of a website screen scraping of the vendors' website, an XML request sent by HTTP Post, HTTP GET using XML API provided by the vendor, web Services in the form of a SOAP Protocol, and a local database.

8. The method of claim 1, wherein the step of Pricing Request Application presenting the service and price offer summary to the user as a real-time response to the user's internet service pricing request provides the price and offer summary to the user within about 120 seconds of the user initiating the internet service pricing request.

9. The method of claim 8, wherein the step of sending the solicitation to plural internet vendors (50) comprises substantially concurrently sending the solicitation to the vendors (50).

10. The method of claim 1, wherein the user is one of a business consumer located at a business and an agent of the business consumer located at a location other than the business

11. The method of claim 1, wherein the User Service Request Application (10) is a website-based application.

12. The method of claim 1, wherein the pricing request comprising a formatted XML document with a Username and corresponding password, a street address of location to be priced, a phone number of the location to be priced, and user-defined tracking information.

13. The method according to claim 8, wherein the price and offer summary is returned to the user within about 45 seconds of the user initiating the internet service pricing request.

14. The method according to claim 8, wherein the price and offer summary to the user returns within about 30 seconds of the user initiating the internet service pricing request.

15. The method according to claim 3, wherein a database is present so that information obtained during the real-time method for pricing internet services is stored for later retrieval.

16. A real-time method for pricing internet services, comprising the steps of:
a user accessing a User Service Request Application website (10) providing a real-time service and price offer summary responsive to a user-originated internet service pricing request;
the user completing request fields on the User Service Request website to generate the pricing request, the pricing request being output from the user's computer as a properly first formatted XML document;
the user's computer sending the first formatted XML document a Pricing Request Application (30) as an HTTP Post request;
the Pricing Request Application (30), after receiving the pricing request, reformatting the received internet pricing request into an output XML document in a form usable by a Pricing System (40);
the Pricing Request Application (30) sending the output XML document by HTTP Post request to the Pricing System (40);
the Pricing System (40) formatting the output XML document into plural internet vendor service solicitations, each of the solicitations being in a format acceptable to one of the plural vendors (50) and sending the solicitations the appropriate vendors (50);
the Pricing System (40) receiving, responsive to the solicitations, internet service proposals from the internet vendors (50), the received proposals comprising data regarding characteristics of offered internet services and pricing for the offered internet services;
the Pricing System (40) collating the data from the received proposals into the service and price offer summary in which disparate characteristics of the offered internet services from the vendors (50) are grouped into groupings of comparable characteristics of offered internet services with corresponding pricing; and
the Pricing System (40) returning the service and price offer summary to the Pricing Request Application (30) for further forwarding to the User Service Request Application (10); and
the Pricing Request Application (30), after receiving the service and price offer summary, reformatting the service and price offer summary into a returned XML document readable by the User Service Request Application (10) for presenting the service and price offer summary to the user as a real-time response to the user's sent internet service pricing request.

17. The method according to claim 16, wherein the real-time response to the user's sent internet service pricing request occurs within about 120 seconds.

18. The method according to claims 16, wherein The method according to claim 16, wherein the real-time response to the user's sent internet service pricing request occurs within about 45 seconds.

19. The method according to claim 16, wherein the internet vendor service solicitation is in the form of a website screen scraping of the vendors' website, an XML request sent by HTTP Post, HTTP GET using XML API provided by the vendor, web Services in the form of a SOAP Protocol, and a local database.

20. A real-time system for pricing internet services to an internet user, comprising:
a Pricing Request Application; and
a Pricing System,
the Pricing Request Application being an XML API application for i) receiving a first XML document, by HTTP Post, containing an internet service pricing request, and ii) after receipt of the first XML document, to reformat the internet service pricing request an output XML document, and
the Pricing System operatively connected to receive the output XML document and thereafter to format application data from the received XML document into a plurality of internet vendor solicitations, each of the solicitations being in a format acceptable to one of the plural vendors and sending the solicitations to the appropriate vendors.
